(19) United States
(12) Patent Application Publication
(10) Pub. No.: US 2016/0144935 A1
(43) Pub. Date: May 26, 2016

(54) METHODS AND SYSTEMS FOR SELECTIVE WAX APPLICATION ON A SPORTS IMPLEMENT

(71) Applicant: Wax Traks, Incorporated, San Clemente, CA (US)

(72) Inventors: Robert Collins Harrell, San Clemente, CA (US); Jaron Collins Harrell, San Clemente, CA (US)

(73) Assignee: Wax Traks, Incorporated, San Clemente, CA (US)

(21) Appl. No.: 14/947,104

(22) Filed: Nov. 20, 2015

Related U.S. Application Data
(60) Provisional application No. 62/082,975, filed on Nov. 21, 2014.

(51) Int. Cl. B63B 35/79; B32B 3/30; B32B 38/10; B32B 37/12; B32B 3/26; B32B 7/12

(52) U.S. Cl. CPC B63B 35/7906; B32B 3/266; B32B 7/12; B32B 38/10; B32B 37/12; B32B 3/30; B32B 2255/24; B32B 2307/744; B32B 2475/00

(57) ABSTRACT

Accessories for sports apparatuses are shown and described. The sports apparatuses may be surfboards. The accessories take the form of thin layers of material for application to an area where selective patterning of wax is desired. The accessories include patterned textures which selectively encourage wax accumulation in desirable patterns. Illustrative accessories may have single or multiple layers, and allow for ready removal of old, used and/or dirty wax with less effort than conventional approaches.

The present application claims priority to and the benefit of U.S. Provisional Patent Application No. 62/082,975, filed Nov. 21, 2014, the disclosure of which is incorporated herein by reference.

### BACKGROUND

The art of surfing has evolved and progressed significantly in the last 20 years. Materials and designs used to manufacture surf boards have improved as has the ability of surfers to perform radical maneuvers. Throughout this progression it has been necessary for surfers to apply a coating to the top surface of their surf boards providing fraction to an otherwise slippery surface. Early on, paraffin wax was most commonly used to provide this traction by melting and dripping wax onto the board. Later came the development of sticky waxes which are sold under common brand names such as Sex Wax® and Sticky Bumps®.

In the 1990's the traction pad with adhesive backing was invented and patented (see, for example, U.S. Pat. Nos. 5,435,765 and 5,308,271), providing an alternative to the traditional application of wax. When first introduced, it was common to see a traction pad applied to the tail or back area as well as the middle area of the deck providing traction for both the back and the front foot. Over time, the traction pad for the front foot fell out of favor while a traction pad on the tail for the back foot remains the most common form of traction applied to short high performance surf boards today.

The application of sticky wax on the middle of the deck providing traction for the front foot remains the most common form of traction applied to surf boards Sticky wax may be applied all the way to the nose of the surf board as radical and progressive aerial maneuvers require skilled surfers to utilize the entire length of the surfboard to complete. It is unusual to see longboards with a traction pad on the tail as they are typically covered from tail to nose with sticky wax because surfers on longboards can walk the entire length of the board during a ride.

Surfers apply sticky wax to the top of their boards by slowly rubbing a bar of wax back and forth and in circular motions across the area to be covered with wax. As the wax is applied, it naturally tends to “bead up” or form small bumps which grow in size as the surfer continues to gently rub the bar of wax over the surface.

Often, a wax having harder properties is used to form a first layer of bumps. This first layer can be called a base coat. Once an acceptable pattern of bumps is formed as a first layer, the surfer switches to a bar of wax with different hardness properties according to the temperature of the water they will be surfing in. The second layer of wax is softer and stickier than the base coat. The surfer continues to build upon the bumps with this stickier wax until the desired area is covered with a layer of wax that is both sticky and textured with bumps to provide traction.

An experienced surfer takes pride in his or her ability to apply surf wax in such a way as to create effective bumpy patterns for traction. As the surfer uses the board over time, the bumps flatten out. New second layers of wax are applied before each surf session to restore the texture, but over time the wax, including the base coat, loses its shape and becomes dirty. A “wax comb” can then be scraped across the waxed surface with teeth that create ridged texture in the wax, but this texture rarely holds its shape past the first few waves of a session. Some surfers carry a wax comb into the water in their wetsuits to restore a textured surface to the wax during a surf session. When a surfer is no longer satisfied with the traction being provided by the wax on their board, they must scrape or melt off all of the old wax, including both the base layer and the second layer. The surfer then cleans the board and starts over with a fresh wax application.

Most surfers would prefer to change their wax and have fresh “bumps” frequently, but the process of removing the old wax is time consuming and messy. Other alternative traction options include a spray-on textured coating which cannot be removed from the board. The spray-on coating has not gained popularity as it is not as sticky as the wax and if wax is applied over it, the underlying rough texture does not allow easy or clean removal of old wax. Another option is the pre-fabricated wax traction pad (for example, U.S. Pat. No. 5,756,204). The patented wax traction pad does not provide for a wax traction texture beyond the use of a wax comb and does not maintain its shape well.

New and alternative solutions to the problem of secured footing on sporting implements, such as surf boards, are desired.

### SUMMARY OF THE INVENTION

The present invention, in a first embodiment, takes the form of a thin material having a first side and a second side, in which the first side is coated with removable adhesive for adhering to the surface of a sports implement such as a surfboard. The thin material may be formed as a laminate. The second side has a surface intended to face away from the sports implement and is fabricated with a three dimensional pattern and texture. The three dimensioned pattern and texture encourages formation of bumps when sticky surf wax is rubbed over the second side, assuring a high quality and consistent wax pattern for improved traction. The material can be fabricated in a variety of sizes and shapes to fit the variety of surfboard sizes and shapes on the market and cover different amounts of deck the user wishes to cover with wax. This first embodiment may be described as an accessory for a sports implement or surfboard.

A second embodiment of the invention takes the form of a thin vinyl manufactured such that it is not of uniform thickness and has a raised or embossed pattern on the top surface and a re-positionable adhesive on the back surface allowing it to be placed on the surfboard and waxed over providing a solid and stable pattern for traction upon which new wax can be added when needed without flattening out the fraction pattern. When the wax becomes old and dirty and the surfer desires to replace the wax, the material can be quickly and easily peeled off the surfboard and discarded along with all of the wax applied over it. This provides a quick and easy removal of old wax with much less mess, making it easy and convenient to replace the wax more frequently. The sheet material can be manufactured with a variety of designs and patterns as well as color designs and patterns giving a desirable visual effect to the waxed area of the board. In another embodiment, the thin sheet with adhesive backing can have a textured ink pattern screen printed onto the non-adhesive surface. When this embodiment applied to the surfboard and sticky surf wax is rubbed over it, the rough texture of the printed pattern will accumulate mounds of wax creating the desired wax bump pattern for foot traction. A line may be printed down the center of the sheet to help align the sheet when applied to the surfboard by matching it to the visible line of the stringer running down the center of a surfboard.

A wide variety of manufacturing techniques and materials that are known in the art of film, decal, sticker, laminate and vinyl sheeting production can be used to create this thin layer of material that sticks to the surfboard and provides an improved traction area when wax is applied over the top of it. These can include techniques and materials such as injection molding, 3D printing, embossing, screen printing, vacuum molding, high pressure molding, decal cut and weeding, vinyl, latex, litho stock, etc. A textured or roughened pattern may also be created by embedding silicon carbide, aluminum oxide grit or the like into acrylic resin, PVC film sheet, or adhesive films.

In another embodiment, a sheet of material is manufactured for placement on a sports implement such as a surfboard. The sheet of material may be formed of a material having properties that encourage wax to stick to the sheet of material itself, with a pattern being formed thereon with a slippery substance to selectively create areas on which wax will not accumulate as readily as areas lacking the pattern. For example, a sheet of material having a grit blended with vinyl or PVC can be coated with a more slippery form of vinyl or screen printed with a low grit ink.

In another embodiment, multiple layers of film may be applied together to the surfboard with surf wax subsequently applied over the top layer. Two or more of the individual layers may include patterns made by screen printing or other techniques noted above. When the surfer desires to quickly and easily remove the old wax and apply a new coat of wax, the top layer of film may be peeled away and discarded with the old wax leaving the remaining layers of clean film still applied to the surf board ready for a fresh application of surf wax. This convenient process may be repeated numerous times depending on how many layers of material where applied together to the surf board.

Another embodiment takes the form of a method of applying wax to a sports implement comprising applying a sheet of material having an adhesive on at least one side to the sport implement. In this embodiment, the sheet of material has a first pattern formed on at least one side thereof by screen printing, embossing or any other method described above. Next, a user applies wax to the area of the sheet of material, and the first pattern formed on the sheet of material encourages wax accumulation in desired areas thereof. The sheet of material itself may come with wax already applied or may be free of wax entirely. The sheet of material may comprise a plurality of layers, and the method may further include removing a first layer of the sheet of material to expose a second pattern and then applying wax on the second pattern.

In some examples, in place of or in addition to the patterning provided by embedding or applying materials, a pattern may be provided by the use of perforation or surface marring, if desired, to create edges or rough places in the surface of a thin piece of material to capture wax thereon. Perforation may be achieved by hand-punching locations or using an automated process. Patterned perforation may be achieved using a large area pre-patterned set of punches or by applying individual punching apparatus(es) across the face of a piece of material. Surface marring may be achieved by chemical or mechanical abrasion, heating, freezing, laser etching or other process that causes an otherwise smooth surface to become rough in certain locations, or may be achieved by using like processes to selectively smooth surface areas of an otherwise rough material.

In another embodiment, a thin sheet having a pattern thereon with rougher and smoother areas encouraging selective wax accumulation is provided with perforations or other small openings. By providing perforations or other small openings, the application of the thin sheet of material is made easier, as a solid sheet can entrap air bubbles. For example, when a larger sheet of material is cut into smaller pieces sized for use on a sports implement such as a surf board, the smaller pieces may themselves be punched or otherwise perforated to allow entrapped air to escape when the smaller pieces are placed on individual sport implements. In one example, the perforations made for ease of application may double as elements of a preferred pattern for wax application.

### BRIEF DESCRIPTION OF THE DRAWINGS

FIG. 1 illustrates an ordinary surf board shown from above;

FIG. 2 illustrates another view of a surf board;

FIG. 3 shows a surf board with a first embodiment of the present invention applied thereto;

FIG. 4 illustrates a second embodiment generally similar to the first embodiment, as applied to a surf board, but using a different texture pattern;

FIG. 5 is similar to FIGS. 3 and 4 but illustrates another texture pattern;

FIG. 6 is a cross-sectional view along line 6-6 of FIG. 5;

FIG. 7 shows a multi-layered embodiment applied on a surfboard;

FIG. 8 shows several embodiment in isolation; and

FIG. 9 is a block diagram illustrating a representative method.

### DETAILED DESCRIPTION

The following detailed description should be read with reference to the drawings. The drawings, which are not necessarily drawn to scale, depict illustrative embodiments and are not intended to limit the scope of the invention. Any reference to other patents, patent applications, products or publications is intended as illustrative of related or useful methods or devices and is not intended to foreclose suitable alternatives.

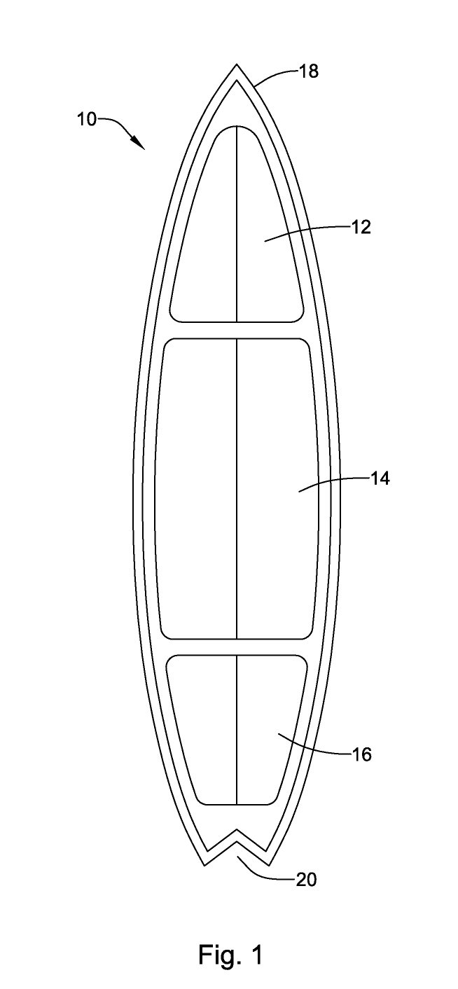

FIG. 1 illustrates a surfboard shown from above in an elevation view. The surfboard 10 includes a deck having front 12, middle 14, and rear 16 regions extending from the nose 18 to the tail 20. The user stands on the board, generally with one foot near the rear region 16 and the other foot on one of the front 12 or middle 14 regions. The user may move about the deck surface during maneuvers. As noted in the background, rear region 16 can often include a traction pad, while the front and middle regions 12, 14 often have wax applied thereto. User preferences vary widely, however, as do the particulars used with differently sized and designed boards.

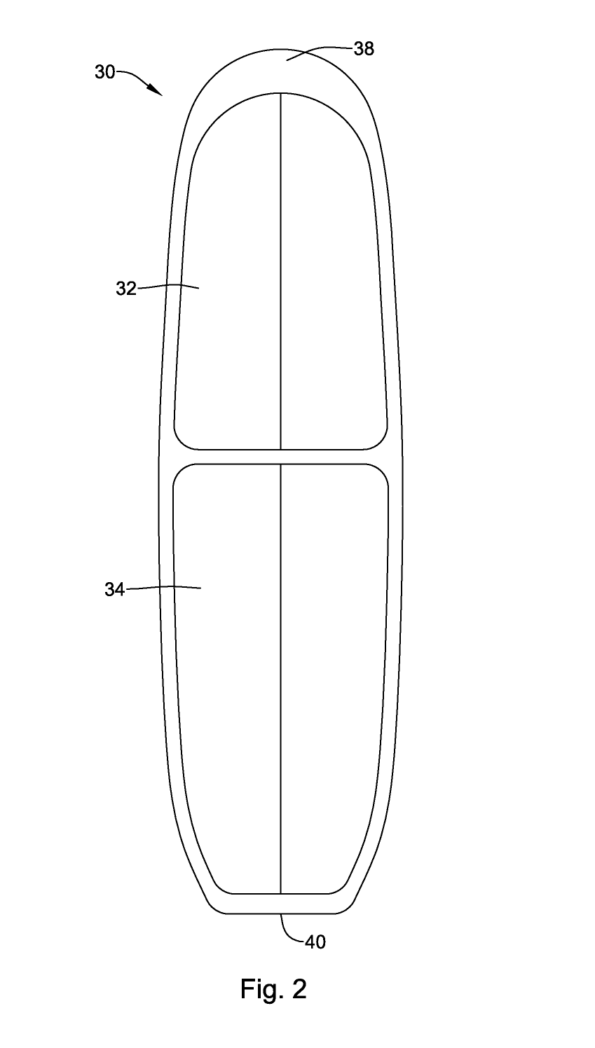

FIG. 2 illustrates a perspective view of a surf board 30. Here the deck surface is divided into front region 32 and rear region 34. A fin (not shown) may extend from the opposite side of the board of that shown. The nose 38 and tail 40 can be seen to have different shapes than in the board 10 of FIG. 1. For purposes of the present invention, any board shape, size or material may be used, with any nose or tail design, as well as any rocker design, bottom shape and/or fin shape/design/quantity. For illustrative purposes, common constructions use a polyurethane foam board material, with a stringer of stronger material down the middle, covered with one or more layers of fiberglass cloth and resin. One or more fins and a leash plug may also be attached. Other constructions are also known.

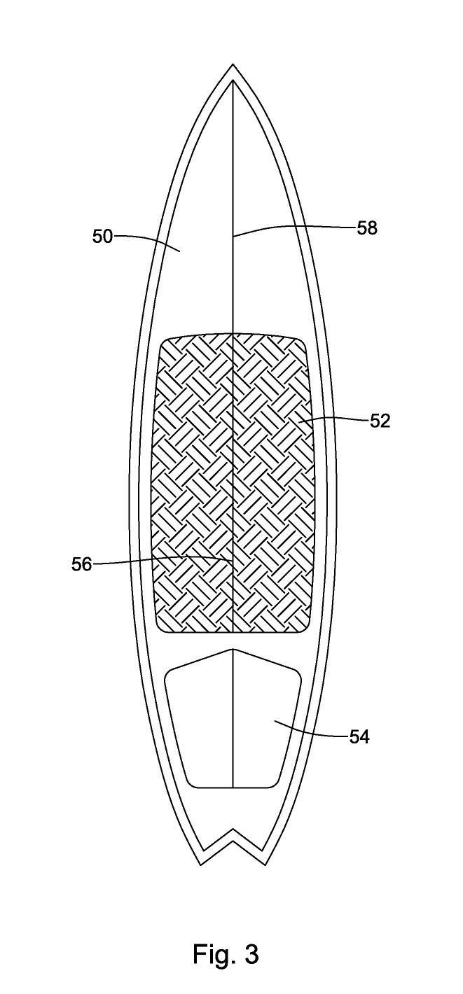

FIG. 3 shows a surf board with a first embodiment of the present invention applied thereto. The board 50 includes a first embodiment of the present invention in the form of an accessory 52 placed on the deck, with a rear-placed traction pad shown at 54. The accessory 52 comprises a thin sheet of material having a patterned texture thereon. In an illustrative embodiment, the patterned texture is a three-dimensional pattern which can be generated by raising or embossing a pattern onto a sheet of vinyl. The accessory 52 is shown including a registration line 56 for alignment with the midline 58 of the board 50.

In another illustrative embodiment, the patterned texture is generated by screen printing ink onto a flexible material such as a thin plastic or vinyl. A wide variety of manufacturing techniques and materials that are known in the art of film, decal, sticker, laminate and vinyl sheeting production can be used to create an accessory 52 of a thin layer of material that sticks to the surfboard and provides an improved traction area when wax is applied over the top of it. These can include techniques and materials such as injection molding, 3D printing, embossing, screen printing, vacuum molding, high pressure molding, decal cut and weeding, vinyl, latex, litho stock, etc. A textured or roughened pattern may also be created by embedding silicon carbide, aluminum oxide grit or the like into acrylic resin, PVC film sheet, or adhesive films. A pattern may be generated by applying perforations or surface marring elements (such as needles) to the accessory 52. A negative pattern may be formed by smoothing out selected portions of the surface of the accessory 52, whereby the surface of the accessory is rather rough to being with.

A first pattern is shown in FIG. 3 as basically a cross-hatching of dash shapes, which may be in the range of 5 millimeters to 3 centimeters across and anywhere from 1 centimeter to 10 centimeters in length, though wider, longer, shorter, and/or narrower shapes may also be used. Other shapes are shown below. Unless specifically recited, the actual pattern used may vary widely. Some additional illustrations are shown in later figures.

The pattern is “textured”, insofar as it represents a raised or lowered region, or may represent an area of different tackiness, lubricity or grit than other regions around it, such that when board wax is applied to the board 50 over the accessory 52, the wax tends to accumulate in a pattern. The pattern may be “positive” in that wax tends to adhere to the area of the pattern, in which case the pattern could be made, for example, by roughening an area or applying a high grit ink. The pattern could also be “negative” in that wax tends to adhere only where the applied pattern is absent, for example by starting with a rough or roughened material and adding a low-grit ink, or smoothing portions.

A prototype of the accessory 52 was made using a 4.0 mil (approximately 0.1 mm) clear vinyl having a low tack adhesive on one side, making it a removable vinyl. A glitter ink was screen printed in a pattern of similar to that shown in FIG. 3. The ink mixture comprised a light-curable clear ink into which glitter is embedded. An alternative using aluminum oxide powder in place of the glitter may also be implemented. Other inks may be used instead. The vinyl base material is available commercially as FLEXmark® V 400 H Clear V-327 90 PFW pressure sensitive film. For purposes of the prototype, it was found that wiping the board with acetone prior to application helped keep the accessory 52 well adhered and avoided premature peeling.

Some examples may include curved corners as shown, for example, in FIG. 3. A sharp corner may promote peeling prematurely—that is, the intent is primarily that a user can continue using the accessory 52 until he or she wishes to remove it. Sharp corners may have a tendency to peel before the user is ready to remove the accessory, and so the corners may be rounded off as shown in several examples.

The sports apparatus may be used on any type, size or shape of surfboard, such as a skimboard, wakeboard, longboard, shortboard, Instead of a surfboard, the sports apparatus may instead be a stand-up paddle board. Another possibility is a board for windsurfing or bodysurfing. Various other sports making use of wax on a surface for footing or other purposes may also integrate embodiments of the present invention.

In some examples, the wax may also accumulate, to some extent, in the region around the accessory on the board deck. As a result, once the accessory is removed completely, it may be necessary to remove the wax that accumulates around the accessory before a new one can be applied. One solution is to provide multi-pack sets of the thin sheet accessories, in which the accessories are each of the same size or slightly different sizes such that a topmost layer can be removed, leaving in place a new material base for the user to apply wax upon while taking away most of the existing wax. In another example, a largest size can be applied first and removed, followed by a slightly smaller size and a still smaller size, with the smallest size being up to a centimeter narrower and shorter than the largest size in an illustrative embodiment, to allow replacement without complete cleaning of wax off of the board. With such a package, the user would only need to perform a full cleaning every fourth application of the base wax.

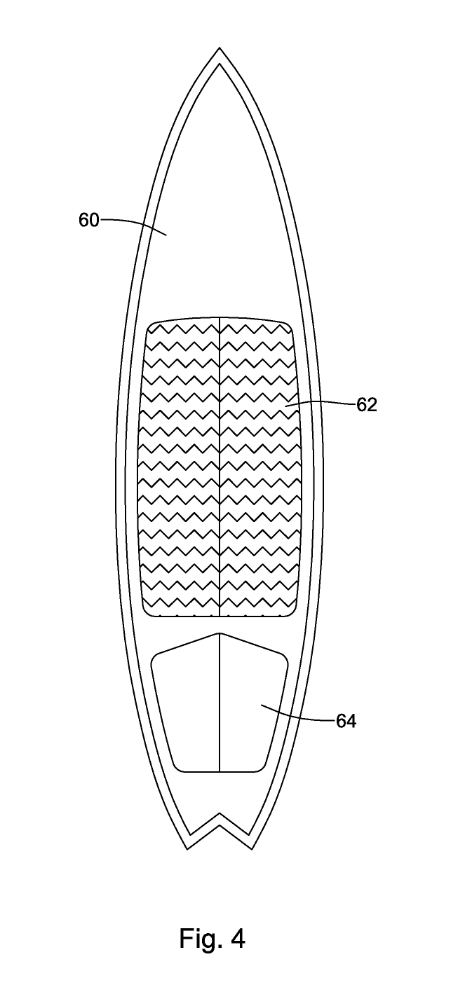

FIG. 4 illustrates a second embodiment generally similar to the first embodiment, as applied to a surf board, but using a different texture pattern. Here the accessory 62 is applied to board 60 which again is shown with the optional traction pad at 64. In the example of FIG. 4, the accessory 62 has a wavy pattern.

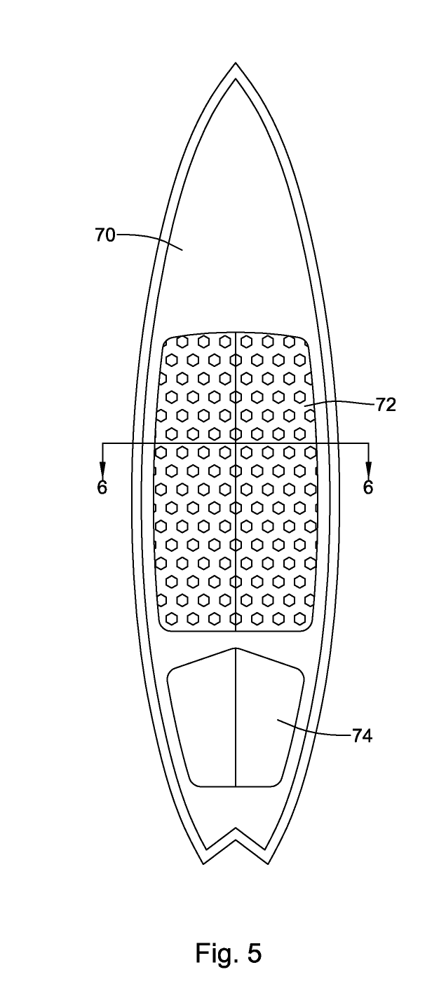

FIG. 5 is similar to FIGS. 3 and 4 but illustrates another texture pattern. Again the accessory 72 is applied to board 70 and an optional traction pad is shown at 74. The traction pad 74 could be replaced with another accessory 72, though the additional accessory may use a different shape or pattern. In the example of FIG. 5, a pattern of dots is shown; the dots may be of any suitable size or pattern. As shown, a generally symmetric, alternating pattern of dots of approximately 5 millimeters to 5 centimeters in diameter is shown, with distances between the dots of anywhere from 1 centimeter to 10 centimeters.

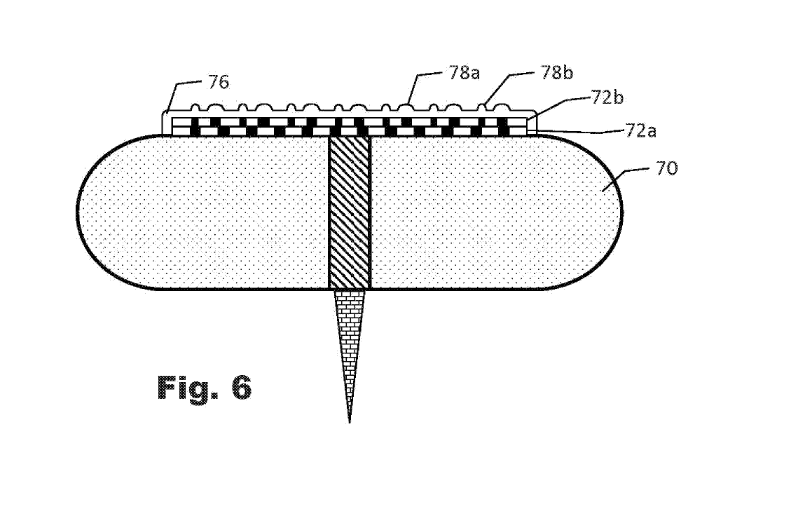

FIG. 6 is a cross-sectional view which could be taken, for example, along line 6-6 of FIG. 5. The cross section shows that board 70 has upon it the accessory which includes two layers 72a and 72b. The upper layer 72b is exposed, while the lower layer 72a is secured to the upper layer 72b by lamination (for example, compressing the layers together) and/or adhesive. Wax 76 has been applied over the layers 72a/72b of the accessory. The thicknesses of each of the layers 72a/72b and wax 76 are exaggerated for illustrative purposes.

The wax 76 is applied, in the example, beyond the outer edges of the layers 72a/72b of the accessory to provide a seal around the accessory and keep water from delaminating the layers 72a/72b prematurely, though this sealing is optional and may not be necessary. The seal provided by the wax 76 may also prevent the accessory 72a/72b from peeling away from the board 70.

As can be seen above layer 72b, the wax as applied accumulates in thicker regions over the pattern, which is shown as black dots. This patterning of the wax as it is applied has been found to work by the inventors in various prototypes, generating a useful wax pattern. Larger/thicker pattern lines may yield larger bumps as shown at 78a, rather than smaller bumps as shown at 78b.

Another variant is shown in FIG. 6 insofar as the two layers 72a and 72b have different patterns on each. Such alternating patterns may allow for decorative designs to be generated. While FIG. 6 shows the wax layer 76 as covering the entire surface of the accessory and going around the accessory, this is not necessary. Instead, the wax may selectively accumulate only in certain regions on the accessory top layer 72b, such that in certain areas the accessory is what the user's feet contact.

As shown by FIG. 6, the pattern may stop short of the outermost edges of the accessory layers 72a/72b to define a pull-back region having a width in the range of about 1 to 20 millimeters, with several prototypes using about 0.25 inches (about 6.4 mm). The pull-back region may promote sealing at the outer edges of the accessory layers 72a/72b, and may prevent peeling prematurely. The pull-back region may be incorporated in any of the examples shown herein, for single or multiple layers. In some examples, if different patterns are used in different accessory layers 72a/72b, the pullback region may appear in each layer 72a/72b, or, alternatively, may appear only in the layer 72a adjacent the board 70.

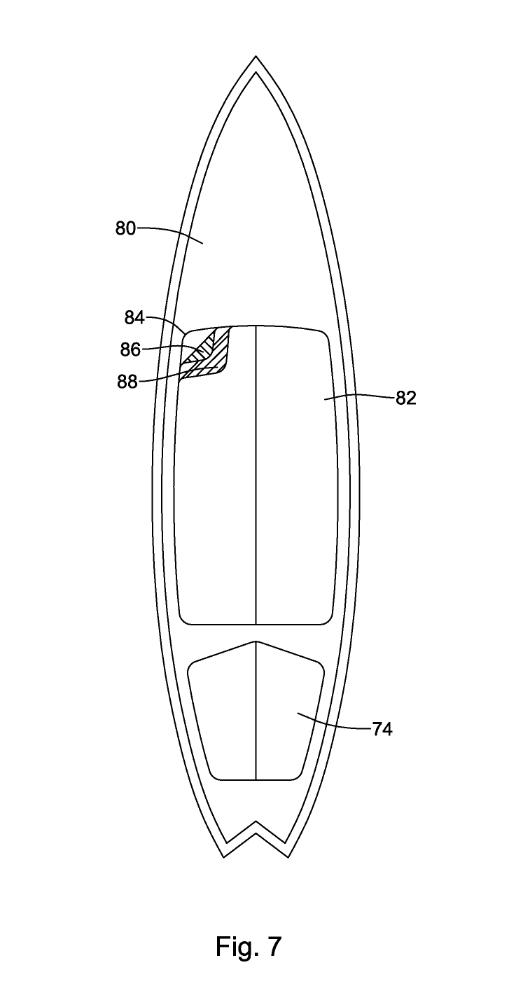

FIG. 7 shows a multi-layered embodiment. The accessory 82 is applied to board 80 and is shown as layers 84, 86 and 88. Each layer may be peeled off as the user desires. Since the accessory 82 covers the portion of the deck that is most used, it also tends to be the area on which dirt mixed with wax will accumulate. As a result, when the top layer 88 is removed, accumulated dirt and old wax will peel off with the top layer 88, making it easier for the user to start fresh, applying wax now on the clean second layer 86. Two layers are shown in FIG. 6, and three in FIG. 7; indeed, any number of layers can be applied. Another feature in FIG. 7 is that the accessory 82 is shown without a visible pattern. Since the actual pattern is simply a texture, there is no reason that a colored ink or ink of different color than the base material would have to be used. Thus, no visible pattern may appear, even if a textured pattern is provided that allows the user to have the wax pattern that is desired, without showing off any particular pattern on the accessory 82 itself.

In an example, the top layer 88 is slightly larger than the intermediate layer 86, which is in turn larger than the base layer 84. This may allow sequential removal without requiring full cleaning of the board 80, as each layer when removed will expose a clean inner layer surrounded by a clean region of the board 80. For example, each layer may be 1 cm narrower and shorter than the prior layer. In another example, the change works in the opposite manner, with the base layer 84 being largest and the top layer 88 being smallest. If desired, for user convenience, each layer may have a marker to indicate which one it is so that the user knows how long before a new appliance 82 must be ordered.

In an example, each layer 84, 86, 88 has its own adhesive layer provided, such that an adhesive layer appears between layer 84 and the board 80, and also between layers 84/86 and 86/88. In another example, only layer 84 has adhesive applied thereto, for sticking to the board 80, while the multiple layers may be laminated together during manufacturing. Thus, for examples, a manufacturing process may include printing a pattern on each of three layers of material (the pattern selected to allow a user to attain a desirable wax pattern), cutting each layer to shape/size, placing three layers together and laminating them together by pressure/heat (for example), perforating the three layers as a unit (to avoid entrapping air during application to a board), and then applying adhesive to one side of the overall structure. A removable cover layer may be provided over the adhesive to make handling easier. As noted, in an alternative approach each layer may include an adhesive thereon, avoiding the lamination step. If each layer has adhesive, perforation of individual layers may take place earlier in the process to facilitate securing one layer to another without entrapping air.

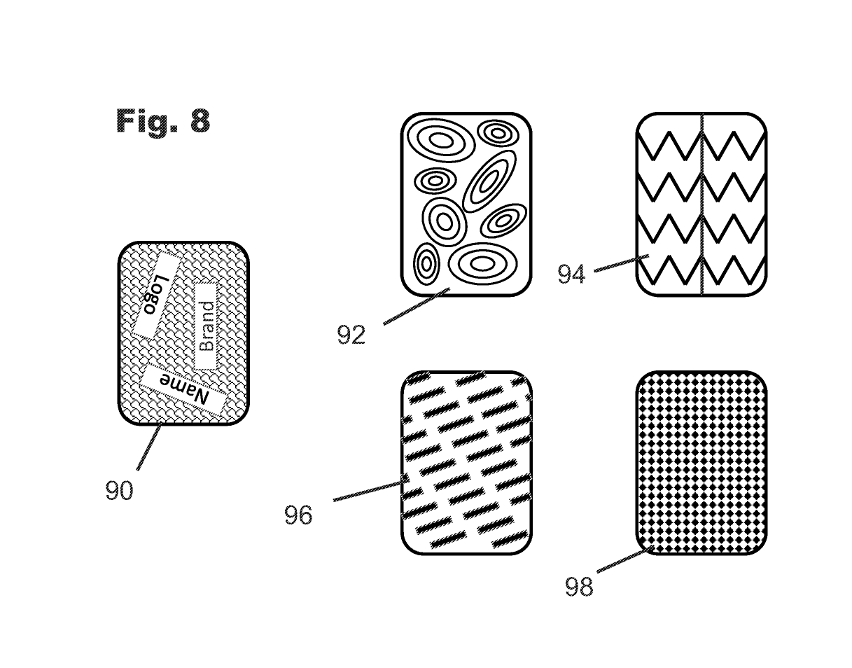

FIG. 8 shows several embodiment in isolation. Textured patterns may include a background texture having names, brands or logos thereon, as shown at 90. Because the texturing can be performed using clear ink, a visible background including artwork, logos or brand names could be provided independent of the textured pattern intended to accumulate wax that results. For example, a visible printed ink design could be applied on a first side of a thin flexible sheet of material, with adhesive over top of the visible design, while a clear textured pattern is provided on the opposite side of the thin flexible sheet of material to facilitate wax patterning. To identify layers of a multi-layer design, different colors could be used so that as each layer is removed, a different visible design color is used. Opaque materials may also be used for the thin flexible sheet of material.

Other possible visible patterns are shown in FIG. 8 including ovals and concentric circles 92, waves 94, dash patterns 96, or a smaller texture as shown at 98. Such patterns may serve as only the visible design or may be used as the patterned texture as well. As highlighted in particular with pattern 94, a registration line may be provided to allow the user to align the accessory with the center of the board deck.

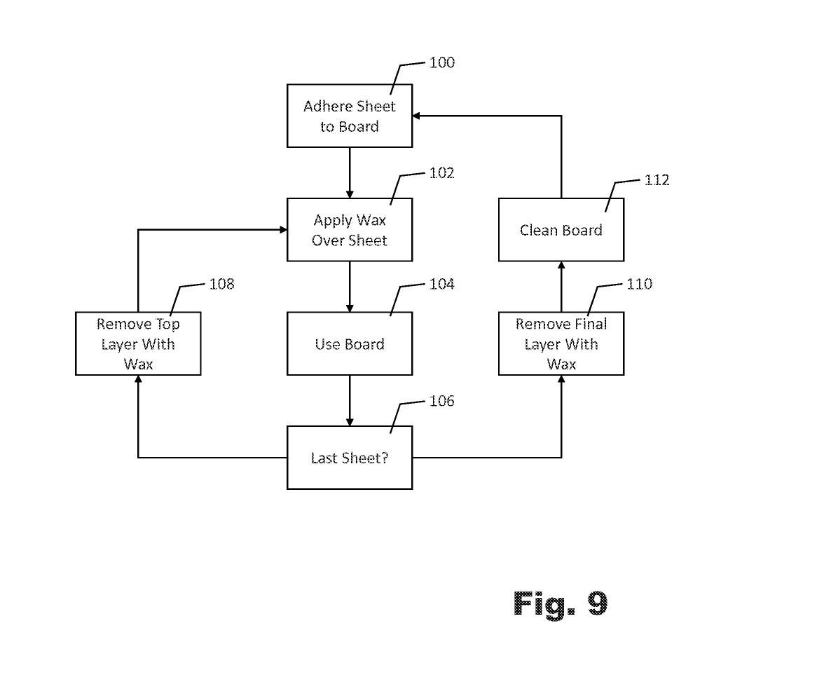

FIG. 9 is a block diagram illustrating a representative method. At block 100, the user applies an accessory in the form of a relatively thin sheet of material to the surfboard. The user then applies wax over the accessory/sheet, as noted at 102. After using the board 104, the user can decide whether and when to remove the used wax and accessory/sheet. Once the user wishes to make a change, the next step depends on whether the last sheet is left on the board, as noted at 106. If there is more than one sheet left on the board, the user simply removes the top layer of the accessory with the wax still stuck on the top layer as shown at 108, and then reapplies wax over the newly exposed sheet of the accessory, returning to block 102. If the final sheet is left on the board, the user will remove the final layer of the accessory and accumulated wax at 110, and can then optionally clean the board at 112, and applies/adheres a new accessory/sheet to the board 100, restarting the process. If the user does clean the board 112, much of the work will already be done by simply peeling off the last layer of the accessory at block 110.

If a single layer accessory is used, the method simply omits blocks 106/108 and goes directly to block 110 when the user wants to make a change.

In any of the above embodiments, an accessory comprising a thin sheet having a pattern thereon with rougher and smoother areas encouraging selective wax accumulation may be provided with perforations or other small openings. By providing perforations or other small openings, the application of the accessory to a board can be made easier, as a solid sheet can entrap air bubbles. For example, when a larger sheet of material is cut into smaller pieces sized for use on a sports apparatus such as a surf board, the smaller pieces may themselves be punched or otherwise perforated to allow entrapped air to escape when the smaller pieces are placed on individual sport apparatuses. Perforation may occur prior to cutting individual pieces as well.

In early prototypes, perforations have worked quite well to aid in placing the thin film of the accessory on a surfboard deck. It has been noted that perforations punched from the bottom or adhesive side may be better optimized to this application, as perforations punched down from the non-adhesive side may result in displaced edges which can impair seating of the accessory on the board deck.

If perforation is used both for pattern placement as well as for aid in device use, the perforations for each purpose may be the same or may be different. For example, a multi-layer product may have individually perforated layers therein to provide a desirable pattern for wax placement, while the overall product may have further perforations added to facilitate ready placement and avoid entrapped air.

A first non-limiting example takes the form of an accessory for a surfboard comprising: a thin sheet of material having a first side and a second side; an adhesive on the first side of the thin sheet of material; and a patterned texture on the second side of the thin sheet of material designed to encourage accumulation of wax in a desired pattern; wherein the thin sheet of material is sized for placement on a surfboard.

A second non-limiting example takes the form of an accessory as in the first non-limiting example, wherein the thin sheet of material is perforated to allow escape of entrapped air during application to a surfboard. A third non-limiting example takes the form of an accessory as in either of the first or second non-limiting examples, wherein the thin sheet of material comprises a registration line for aligning the accessory to a desired location on a surfboard. A fourth non-limiting example takes the form of an accessory as in the third non-limiting example, wherein the registration line is placed along the center of the thin sheet of material for alignment to the midline of a surfboard.

A fifth non-limiting example takes the form of an accessory as in the first non-limiting example, wherein the thin sheet of material is a vinyl material, and the pattern is formed by screen printing on the second side. A sixth non-limiting example takes the form of an accessory as in the first non-limiting example, wherein the patterned texture takes the form of a pattern selected from the set of patterns consisting of a series of wavy lines, a set of dots, and cross-hatching.

A seventh non-limiting example takes the form of an accessory as in any of the first to sixth non-limiting examples, wherein the patterned texture is formed with a generally clear ink. An eighth non-limiting example takes the form of an accessory as in any of the first to sixth non-limiting examples, wherein the patterned texture is formed with a visible ink. A ninth non-limiting example takes the form of an accessory as in any of the first to sixth non-limiting examples, wherein the patterned texture is formed by making a pattern of perforations in the thin sheet of material.

A tenth non-limiting example takes the form of an accessory as in any of the first to ninth non-limiting examples, wherein the thin sheet of material comprises: a first layer having a first side and a second side; a second layer having a first side and a second side; wherein: the first side of the first layer is also the first side of the thin sheet of material; the second side of the second layer is also the second side of the thin sheet of material; the first side of the second layer is adhered to the second side of the first layer; the second side of the first layer includes a patterned texture designed to encourage accumulation of wax in a desired pattern; and the second layer is removable from the first layer to expose the second side of the first layer; such that a user can apply the surfboard accessory to a surfboard and apply wax to the second side of the second layer, later remove the second layer, and, following removal of the second layer, apply wax to the second side of the first layer.

An eleventh non-limiting example takes the form of an accessory as in the tenth non-limiting example, wherein the first and second layers are adhered together using an adhesive. A twelfth non-limiting example takes the form of an accessory as in the tenth non-limiting example, wherein the first and second layers are adhered together by lamination. A thirteenth non-limiting example takes the form of an accessory as in the tenth non-limiting example, wherein the first layer and second layer each have the same patterned texture. A fourteenth non-limiting example takes the form of an accessory as in the tenth non-limiting example, wherein the first layer and the second layer each have different patterned textures.

A fifteenth non-limiting example takes the form of an accessory as in any of the first to ninth non-limiting examples, wherein the thin sheet of material comprises at least three layers such that at least two layers may be successively used for selective application of wax and then removed by a user. A sixteenth non-limiting example takes the form of an accessory as in any of the first to fifteenth non-limiting examples wherein the patterned texture stops at a pull-back region near the edge of the accessory.

A seventeenth non-limiting example takes the form of a method for preparing a sports implement for use comprising: applying a thin sheet of material having a patterned texture thereon to the sports implement; and applying wax onto the sheet of material; wherein the patterned texture is designed to selectively encourage wax accumulation on certain regions of the thin sheet of material.

An eighteenth non-limiting example takes the form of a method as in the seventeenth non-limiting example, wherein the sports implement is a surf board, and the wax is a surf wax. A nineteenth non-limiting example takes the form of a method as in either of the seventeenth or eighteenth non-limiting example, wherein the thin sheet of material comprises at least first and second layers, the first and second layers having patterned textures thereon, wherein the step of applying wax onto the sheet of material includes applying wax onto the first layer; and the method further comprises: removing the first layer to expose the second layer, such that both the first layer and some portion of the applied wax are removed; and applying wax onto the second layer.

Those skilled in the art will recognize that the present invention may be manifested in a variety of forms other than the specific embodiments described and contemplated herein. Accordingly, departures in form and detail may be made without departing from the scope and spirit of the present invention.

What is claimed is:

1. An accessory for a surfboard comprising:
a thin sheet of material having a first side and a second side;
an adhesive on the first side of the thin sheet of material; and
a patterned texture on the second side of the thin sheet of material designed to encourage accumulation of wax in a desired pattern;
wherein the thin sheet of material is sized for placement on a surfboard.

2. The accessory for a surfboard of claim 1, wherein the thin sheet of material is perforated to allow escape of entrapped air during application to a surfboard.

3. The accessory for a surfboard of claim 1, wherein the thin sheet of material comprises a registration line for aligning the accessory to a desired location on a surfboard.

4. The accessory for a surfboard of claim 3, wherein the registration line is placed along the center of the thin sheet of material for alignment to the midline of a surfboard.

5. The accessory for a surfboard of claim 1, wherein the thin sheet of material is a vinyl material, and the pattern is formed by screen printing on the second side.

6. The accessory for a surfboard of claim 1, wherein the patterned texture takes the form of a pattern selected from the set of patterns consisting of a series of wavy lines, a set of dots, and cross-hatching.

7. The accessory for a surfboard of claim 1, wherein the patterned texture is formed with a generally clear ink.

8. The accessory for a surfboard of claim 1, wherein the patterned texture is formed with a visible ink.

9. The accessory for a surfboard of claim 1, wherein the patterned texture is formed by making a pattern of perforations in the thin sheet of material.

10. The accessory for a surfboard of claim 1, wherein the thin sheet of material comprises:
a first layer having a first side and a second side;
a second layer having a first side and a second side;
wherein:
the first side of the first layer is also the first side of the thin sheet of material;
the second side of the second layer is also the second side of the thin sheet of material;
the first side of the second layer is adhered to the second side of the first layer;
the second side of the first layer includes a patterned texture designed to encourage accumulation of wax in a desired pattern; and
the second layer is removable from the first layer to expose the second side of the first layer;
such that a user can apply the surfboard accessory to a surfboard and apply wax to the second side of the second layer, later remove the second layer, and, following removal of the second layer, apply wax to the second side of the first layer.

11. The accessory for a surfboard of claim 10, wherein the first and second layers are adhered together using an adhesive.

12. The accessory for a surfboard of claim 10, wherein the first and second layers are adhered together by lamination

13. The accessory for a surfboard of claim 10, wherein the first layer and second layer each have the same patterned texture.

14. The accessory for a surfboard of claim 10, wherein the first layer and the second layer each have different patterned textures.

15. The accessory for a surfboard of claim 1, wherein the thin sheet of material comprises at least three layers such that at least two layers may be successively used for selective application of wax and then removed by a user.

16. The accessory for a surfboard of claim 1, wherein the patterned texture stops at a pull-back region near the edge of the accessory.

17. A method for preparing a sports implement for use comprising:
applying a thin sheet of material having a patterned texture thereon to the sports implement; and
applying wax onto the sheet of material;
wherein the patterned texture is designed to selectively encourage wax accumulation on certain regions of the thin sheet of material.

18. The method of claim 17 wherein the sports implement is a surf board, and the wax is a surf wax.

19. The method of claim 17 wherein the thin sheet of material comprises at least first and second layers, the first and second layers having patterned textures thereon, wherein the step of applying wax onto the sheet of material includes applying wax onto the first layer; and the method further comprises:
removing the first layer to expose the second layer, such that both the first layer and some portion of the applied wax are removed; and
applying wax onto the second layer.
